(19) United States
(12) Patent Application Publication
(10) Pub. No.: US 2020/0112651 A1
(43) Pub. Date: Apr. 9, 2020

(54) IMAGE FORMING SYSTEM AND CONTROL PROGRAM

(71) Applicant: KONICA MINOLTA, INC., Tokyo (JP)

(72) Inventor: Hiroshi SHIMURA, Tokyo (JP)

(73) Assignee: KONICA MINOLTA, INC., Tokyo (JP)

(21) Appl. No.: 16/562,717

(22) Filed: Sep. 6, 2019

(30) Foreign Application Priority Data
Oct. 3, 2018 (JP) 2018-188113

(51) Int. Cl. H04N 1/32; G06F 3/12; H04N 1/00

(52) U.S. Cl. CPC H04N 1/32609; H04N 1/00074; G06F 3/1256

(57) ABSTRACT

Provide is an image forming system and a control program capable of preventing a setting error of an output mode by a user when newly generating a correct image. An image forming system includes an image forming unit, an image reading unit, a reference image acquiring unit, and a control unit. The image reading unit reads the image on the sheet formed by the image forming unit. The reference image acquiring unit acquires a reference image as a reference for determining whether the image of the print job formed on the sheet is normal. The control unit prohibits forming of a plurality of copies of the image of the print job by the image forming unit when the reference image acquiring unit newly generates and acquires a reference image by reading the image formed on the sheet by the image forming unit using the image reading unit.

### CROSS-REFERENCE TO RELATED APPLICATION

The entire disclosure of Japanese Patent Application No. 2018-188113, filed on Oct. 3, 2018, is incorporated herein by reference in its entirety.

### BACKGROUND

### 1. Technological Field

The present invention relates to an image forming system and a control program.

### 2. Description of the Related Art

In recent years, in the production/printing field, there has been an active development of a technology in order to improve printing quality and stabilize image quality. As one of such technologies, there is an image forming system having an automatic inspection function for automatically inspecting an image of a printed material.

In such an image forming system, it is determined whether a printed material of a main printing has sufficient quality by comparing an image of a printed material confirmed by a user to have good image quality (hereinafter referred to as “quality”) with an image obtained by scanning the printed material of the main printing.

Further, an image which is registered in advance can be used as an image of the printed material confirmed to have good image quality (hereinafter, a “correct image”), but the image can be newly generated. When the correct image is newly generated, the same image as the print job of the main printing is printed and the scan image of the printed material is registered in the image forming system as the correct image. Regarding this, there is known a technology of inspecting the quality of the printed material of the main printing by comparing the correct image generated from the scan image of the printed material before the main printing to confirm the quality by the user with the scan image of the printed material of the main printing (for example, see JP 2017-32572 A).

In the image forming system using such a technology, the correct image is generated by generating a print job of printing only one copy of the same image as the image of the print job of the main printing and scanning the printed material while performing the printing based on the print job. Accordingly, only one copy is necessary to generate the correct image. Thus, in order to avoid the unnecessary printing when the correct image is newly generated, for example, proof printing (printing in a trial printing mode of outputting one copy of the print job) is performed instead of the normal printing for printing the image of the print job according to the specified number of copies.

### SUMMARY

However, conventionally, since there is a selection button for a mode capable of printing a plurality of copies such as a normal mode in addition to the proof mode on an output mode setting screen setting the output mode of the print job, there is a possibility that an operation error by the user may occur when generating a new correct image.

The present invention has been made in view of such circumstances and an object of the present invention is to provide an image forming system and a control program capable of preventing a setting error of an output mode by a user when newly generating a correct image.

To achieve at least one of the above-mentioned objects, according to an aspect of the present invention, the image forming system reflecting one aspect of the present invention comprises an image forming unit, an image reading unit, a reference image acquiring unit, and a control unit. The image forming unit forms an image on a sheet on the basis of a print job. The image reading unit reads the image on the sheet having the image formed thereon by the image forming unit. The reference image acquiring unit acquires a reference image for determining whether the image of the print job formed on the sheet by the image forming unit is normal. The control unit prohibits the printing of a plurality of copies of the image of the print job by the image forming unit when the reference image acquiring unit acquires the reference image by generating the reference image while reading the image formed on the sheet by the image forming unit using the image reading unit.

Further, to achieve at least one of the above-mentioned objects, according to an aspect of the present invention, the control program reflecting another aspect of the present invention is a control program allowing an image forming system to perform following steps: (a) forming an image on a sheet on the basis of a print job; (b) reading the image on the sheet having the image formed thereon by the step (a); and (c) acquiring a scan image read by the step (b) as a reference image for determining whether the image formed by a main printing of the print job is normal or not. The control program prohibits the printing of a plurality of copies of the image of the print job in the step (a).

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic cross-sectional view illustrating a configuration of an image forming system of an embodiment;

FIG. 2 is a schematic block diagram of the image forming system illustrated in FIG. 1;

FIG. 3 is a schematic block diagram illustrating a configuration of a control unit of the image forming apparatus illustrated in FIG. 2;

FIG. 4 is a schematic block diagram illustrating a configuration of a control unit of a first post-processing apparatus illustrated in FIG. 2;

FIG. 5 is a schematic diagram illustrating the case of performing automatic inspection setting on a “job ticket editing” screen;

FIG. 6 is a flowchart illustrating a process procedure of a method of controlling the image forming system of the embodiment;

FIG. 7 is a schematic diagram illustrating the case of performing output mode setting on the “job ticket editing” screen;

FIG. 8 is a subroutine flowchart illustrating a process of acquiring a correct image;

FIG. 9 is a schematic diagram illustrating the case of selecting a correct image from a registered image;

FIG. 10 is a schematic diagram illustrating the case of newly generating a correct image;

FIG. 11 is a diagram illustrating a method of prohibiting printing of a plurality of copies of a print job;

FIG. 12 is a schematic diagram illustrating the case of graying out a selection button other than a “proof” button as one of methods of prohibiting printing of a plurality of copies of a print job;

FIG. 13 is a schematic diagram illustrating a modified example of correct image setting;

FIG. 14 is a schematic diagram illustrating the case of printing one copy of an image of a print job by a “sample output” mode; and

FIG. 15 is a schematic diagram illustrating the case of performing newly generating of a correct image from an “output mode setting” screen.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, the same reference numerals will be given to the same components and the description of the redundant description will be omitted. Further, the dimensional proportions of the drawings are exaggerated for the convenience of the description and may be different from the actual proportions.

### Embodiments

<Image Forming System 100>

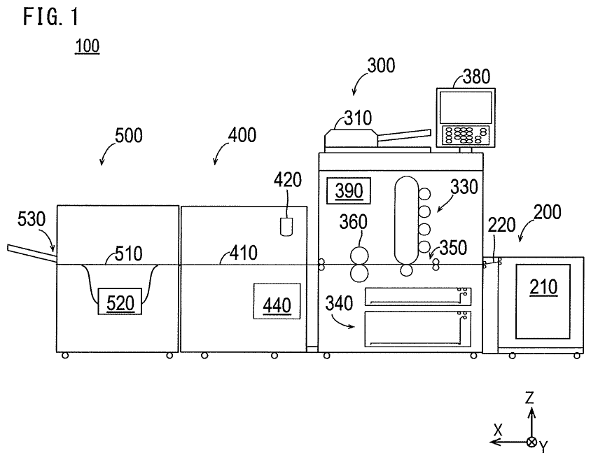

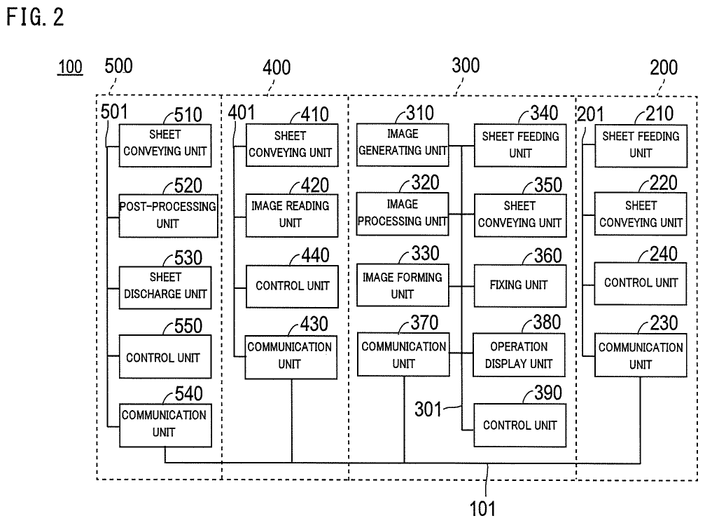

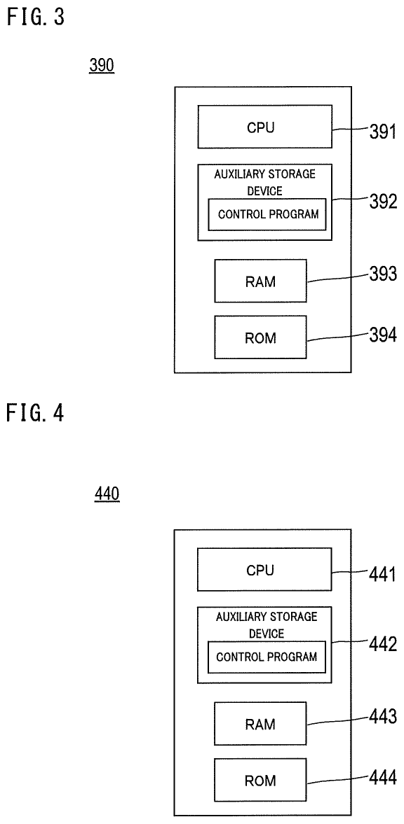

FIG. 1 is a schematic cross-sectional view of an image forming system 100 of an embodiment and FIG. 2 is a schematic block diagram of the image forming system 100 illustrated in FIG. 1. Further, FIG. 3 is a schematic block diagram illustrating a configuration of a control unit 390 of an image forming apparatus 300 illustrated in FIG. 2 and FIG. 4 is a schematic block diagram illustrating a configuration of a control unit 440 of a first post-processing apparatus 400 illustrated in FIG. 2.

As illustrated in FIG. 1, the image forming system 100 of the embodiment includes a sheet feeding apparatus 200, an image forming apparatus 300, a first post-processing apparatus 400, and a second post-processing apparatus 500 which are connected in series in the X direction (the sheet conveying direction). Additionally, the configuration of the image forming system 100 illustrated in FIG. 1 is an example and the type and the number of apparatuses included in the image forming system 100 are not limited to those illustrated in FIG. 1.

<Sheet Feeding Apparatus 200>

The sheet feeding apparatus 200 supplies a sheet to the image forming apparatus 300 in response to an instruction of the image forming apparatus 300. As illustrated in FIGS. 1 and 2, the sheet feeding apparatus 200 includes a sheet feeding unit 210, a sheet conveying unit 220, a communication unit 230, and a control unit 240. The sheet feeding unit 210, the sheet conveying unit 220, the communication unit 230, and the control unit 240 are connected to one another by an internal bus 201.

The sheet feeding unit 210 includes at least one sheet feeding tray and accommodates sheets which are recording materials used for a printing operation. The sheets accommodated in the sheet feeding tray are supplied one by one to the image forming apparatus 300 by a plurality of conveying roller sets along a conveying path of the sheet conveying unit 220.

The communication unit 230 exchanges a control signal or data with the image forming apparatus 300. The control unit 240 controls the sheet feeding unit 210, the sheet conveying unit 220, and the communication unit 230.

<Image Forming Apparatus 300>

The image forming apparatus 300 reads an image from a document and forms (prints) the read image on a sheet. Further, the image forming apparatus 300 receives a print job including print data and print setting data in a PDL (Page Description Language) format from an external client terminal through a network and prints an image on a sheet on the basis of the print job. The client terminal may be, for example, a personal computer, a tablet terminal, a smartphone, or the like.

The image forming apparatus 300 includes an image generating unit 310, an image processing unit 320, an image forming unit (image former) 330, a sheet feeding unit 340, a sheet conveying unit 350, a fixing unit 360, a communication unit 370, an operation display unit 380, and a control unit (control unit) 390. These components are connected to one another by an internal bus 301 for communication.

The image generating unit 310 includes an optical system such as a mirror and a lens and a reading sensor. The image generating unit 310 reads a document placed on a reading surface or a document conveyed by an ADF (Auto Document Feeder) and outputs an image signal.

The image processing unit 320 generates print image data by performing various image processes on the image signal received from the image generating unit 310. Further, the image processing unit 320 generates print image data on the basis of print data and print setting information included in the print job received by the communication unit 370. The generated print image data is transmitted to the image forming unit 330.

The image forming unit 330 prints an image on a sheet on the basis of print image data using a known image forming process such as an electrophotographic method including charging, exposing, developing, and transferring. The image forming unit 330 includes a photosensitive drum which is an image carrier, a charging unit which is disposed around the photosensitive drum, an optical writing unit, a developing device, and a transfer unit.

The sheet feeding unit 340 supplies a sheet to the image forming unit 330. The sheet feeding unit 340 includes a plurality of sheet feeding trays and the sheet feeding trays can respectively accommodate, for example, sheets of different sizes such as A4 and A3 sizes.

The sheet conveying unit 350 includes a conveying path and a plurality of conveying roller sets and conveys a sheet in the image forming apparatus 300. Further, the sheet conveying unit 350 includes a sheet reversing unit and a circulation conveying unit and can turn over and discharge the fixed sheet or can form an image on both sides of the sheet.

The fixing unit 360 fixes a toner image formed on a sheet. The fixing unit 360 includes a hollow heating roller having a heater disposed therein and a pressing roller facing the heating roller. The heating roller and the pressing roller are controlled at a predetermined temperature (for example, 100° C. or more) by the heater and heat and pressure are applied to a sheet to fix the toner image.

The sheet having an image fixed thereto is supplied to the first post-processing apparatus 400 through a sheet discharge unit (not illustrated).

The communication unit 370 is connected to a client terminal such as a personal computer via a network and transmits and receives data such as print jobs.

The operation display unit 380 includes an input unit and an output unit. The input unit includes, for example, a keyboard, a button, and a touch panel and is used for a user to perform various instructions (inputs) such as character input by the keyboard, various settings, and an instruction to start printing by a print start button. Further, the output unit includes a display and is used to present the user with various setting screens such as a job ticket editing screen to be described later, an execution status of a print job, and the like.

The control unit 390 controls the image generating unit 310, the image processing unit 320, the image forming unit 330, the sheet feeding unit 340, the sheet conveying unit 350, the fixing unit 360, the communication unit 370, and the operation display unit 380. As illustrated in FIG. 3, the control unit 390 includes a CPU 391, an auxiliary storage device 392, a RAM 393, and a ROM 394.

The CPU 391 realizes various functions by executing a control program for the image forming apparatus. The control program is stored in the auxiliary storage device 392 and is loaded onto the RAM 393 when the program is executed by the CPU 391. The auxiliary storage device 392 includes, for example, a large-capacity storage device such as a hard disk drive and a flash memory. The RAM 393 stores a calculation result or the like accompanied by the execution of the CPU 391. The ROM 394 stores various parameters, various programs, and the like.

<First Post-Processing Apparatus 400>

The first post-processing apparatus 400 includes a sheet conveying unit 410, an image reading unit (image reader) 420, a communication unit 430, and a control unit 440. These components are connected to one another by the internal bus 401 for communication.

The sheet conveying unit 410 includes a conveying path and a plurality of conveying roller sets and conveys a sheet supplied from the image forming apparatus 300 toward the second post-processing apparatus 500 along the conveying path.

The image reading unit 420 is an in-line sensor (a scanner) provided in the conveying path of the sheet conveying unit 410 and reads an image on a sheet conveyed by the conveying path. The communication unit 430 exchanges a control signal or data with the image forming apparatus 300.

The control unit 440 controls the sheet conveying unit 410, the image reading unit 420, and the communication unit 430. As illustrated in FIG. 4, the control unit 440 includes a CPU 441, an auxiliary storage device 442, a RAM 443, and a ROM 444.

The CPU 441 realizes various functions by executing a control program for the first post-processing apparatus. The control program is stored in the auxiliary storage device 442 and is loaded onto the RAM 443 when the program is executed by the CPU 441. The auxiliary storage device 442 includes, for example, a large-capacity storage device such as a hard disk drive and a flash memory. The RAM 443 stores a calculation result or the like accompanied by the execution of the CPU 441. The ROM 444 stores various parameters, various programs, and the like.

In the embodiment, the image forming unit 330, the control unit 390, the image reading unit 420, and the control unit 440 cooperate to function as a reference image acquiring unit (a reference image acquirer) and generate and acquire a correct image by reading an image printed on a sheet by the image forming unit 330 using the image reading unit 420. The correct image is an image obtained by reading a printed material obtained by printing only one copy of the image of the print job by the image reading unit 420 and the quality is confirmed by the user. In the embodiment, the correct image is used a reference image for determining whether the image of the print job formed on the sheet by the image forming unit 330 is normal or not.

Further, the control unit 440 and the image reading unit 420 function as an image inspection unit (image inspector) in the main printing of the print job. The image inspection unit determines whether the image of the print job formed on the sheet by the image forming unit 330 is normal or not on the basis of the image read by the image reading unit 420 and the correct image.

<Second Post-Processing Apparatus 500>

The second post-processing apparatus 500 conveys or post-processes the sheet supplied from the first post-processing apparatus 400 in accordance with an instruction of the image forming apparatus 300 and discharges the sheet to the outside of the image forming system 100. The second post-processing apparatus 500 includes a sheet conveying unit 510, a post-processing unit 520, a sheet discharge unit 530, a communication unit 540, and a control unit 550. These components are connected to one another by an internal bus 501 for communication.

The sheet conveying unit 510 includes a conveying path and a plurality of conveying roller sets and conveys the sheet supplied from the first post-processing apparatus 400 along the conveying path so that the sheet is supplied to the post-processing unit 520 or the sheet discharge unit 530.

The post-processing unit 520 performs post-processing on the conveyed sheet. As the post-processing, for example, punching, stapling, side stitching, and the like can be exemplified.

The sheet discharge unit 530 includes a sheet discharge tray and a sheet discharge roller set and discharges the sheet supplied from the first post-processing apparatus 400 and conveyed along the conveying path or subjected to post-processing to the sheet discharge tray.

The communication unit 540 exchanges a control signal or data with the image forming apparatus 300. The control unit 550 controls the sheet conveying unit 510, the post-processing unit 520, the sheet discharge unit 530, and the communication unit 540.

<Method of Controlling Image Forming System 100>

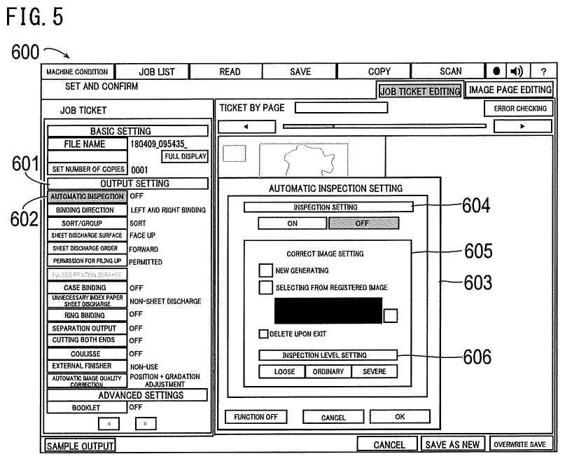

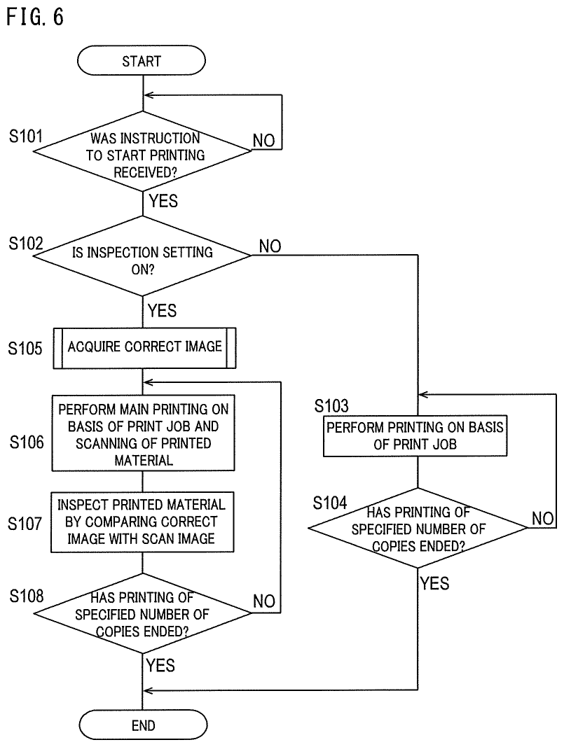

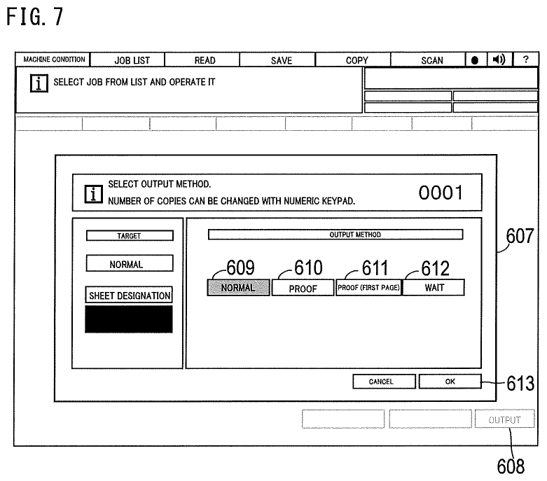

Referring to FIGS. 5 to 7, a method of controlling the image forming system 100 of the embodiment will be described. FIG. 5 is a schematic diagram illustrating the case of performing automatic inspection setting on a “job ticket editing” screen and FIG. 6 is a flowchart illustrating a process procedure of a method of controlling the image forming system 100 of the embodiment. The process illustrated in FIG. 6 is realized by the cooperation of the control unit 390 and the control unit 440. The control unit 390 plays an important role in the overall control and the like of the process of FIG. 6 and the control unit 440 plays the image reading control by the image reading unit 420 or the scan image storage and management, and the like. Further, FIG. 7 is a schematic diagram illustrating the case of performing output mode setting of the “job ticket editing” screen.

Hereinafter, the case of storing the print job for performing the main printing by the image forming apparatus 300 in the auxiliary storage device 392 and setting the output of the print job before the user operates the “job ticket editing” screen to perform the main printing will be described.

The image forming system 100 of the embodiment has an automatic inspection function as one function of the output of the print job and can automatically inspect an image by the correct image in the main printing. Further, the setting of automatic inspection (hereinafter, referred to as “automatic inspection setting”) can be performed on a “job ticket editing” screen 600 (see FIG. 5 and the like).

More specifically, when “automatic inspection” 602 in the item of “output setting” 601 is selected on the “job ticket editing” screen 600, an “automatic inspection setting” screen 603 is launched and various settings relating to automatic inspection can be performed from the “automatic inspection setting” screen 603. Additionally, since the items other than the “automatic inspection” 602 in the items of “output setting” 601 are the same as those of a conventional image forming system having an automatic inspection function, a detailed description thereof will be omitted.

The “automatic inspection setting” screen 603 includes “inspection setting” 604 for setting the ON/OFF state of the automatic inspection function, “correct image setting” screen 605 for newly generating the correct image or selecting the correct image from the registered image, and “inspection level setting” 606 for setting an inspection level. In the example illustrated in FIG. 5, the “inspection setting” 604 is set to an OFF state and the “correct image setting” screen 605 and the “inspection level setting” 606 are not set. The “correct image setting” screen 605 will be described in detail below. Additionally, the “inspection level setting” 606 can set any one of “loose”, “ordinary”, and “severe” as an inspection level. Since the inspection level is the same as that of a conventional image forming system having an automatic inspection function, a detailed description thereof will be omitted.

As illustrated in FIG. 6, the control unit 390 determines whether an instruction to start printing has been received (step S101). More specifically, the control unit 390 determines that the instruction to start printing has been received when an output button on the “job ticket editing” screen 600 or other screens is pushed or a print start button of the operation display unit 380 is pushed.

When the instruction to start printing is not received (step S101: NO), the process waits until the instruction to start printing is given. Meanwhile, when the instruction to start printing is received (step S101: YES), it is determined whether the “inspection setting” 604 is on (step S102). When the “inspection setting” 604 is not on, that is, the “inspection setting” 604 is off (step S102: NO), the control unit 390 performs printing on the basis of the print job stored in the auxiliary storage device 392 (step S103). Then, when the specified number of copies have been printed (step S104: YES), the process ends. Meanwhile, when the specified number of copies have not been printed (step S104: NO), the routine proceeds to the process of step S103 and the printing is continued on the basis of the print job.

Further, when the instruction to start printing is received, an “output mode setting” screen 607 is launched as illustrated in FIG. 7. In the example illustrated in FIG. 7, the case of launching the “output mode setting” screen 607 by selecting the output button 608 is exemplified.

The “output mode setting” screen 607 functions as a mode selection unit (mode selector) and allows the user to select an output method (an output mode) by the image forming apparatus 300. In the example illustrated in FIG. 7, the user can select any one of a “normal” mode, a “proof” mode, a “proof (first page)” mode, and a “wait” mode as the output mode. More specifically, when any one of a “normal” button 609, a “proof” button 610, a “proof (first page)” button 611, and a “wait” button 612 is selected and an “OK” button 613 is selected, a corresponding output mode is performed.

When the “normal” mode is performed, the image forming system 100 prints the number of copies (one or more copies) specified in the print settings of the print job. Further, when the “proof” mode is selected, the image forming system 100 performs proof printing. The proof printing is used for test printing and prints only one copy of the image regardless of the number specified in the print setting of the print job. Meanwhile, when the “proof (first page)” mode is selected, the image forming system 100 prints only the first page of the image. Further, when the “wait” mode is selected, the image forming system 100 displays an image forming condition on the display of the operation display unit 380 and suspends the execution of the print job reserved until an operator performs an output operation.

In this way, when the inspection setting is off, the user can select any one of the “normal” button 609, the “proof” button 610, the “proof (first page)” button 611, and the “wait” button 612. Further, the output mode according to the selection button is performed.

Meanwhile, when the inspection setting is on (step S102: YES), the correct image is acquired (step S105). In the embodiment, the user can acquire the correct image by newly generating the correct image or acquire the correct image from the existing registered image. The acquired correct image is stored in, for example, the auxiliary storage device 442 of the control unit 440. A detailed procedure of acquiring the correct image will be described later.

Next, the printed material is scanned while performing the main printing on the basis of the print job (step S106). The image forming apparatus 300 prints an image one by one using the image forming unit 330 and supplies a sheet (a printed material) having the image printed thereon to the first post-processing apparatus 400. In the first post-processing apparatus 400, the image reading unit 420 reads the image of the printed material and stores the scan image in the RAM 443 of the control unit 440.

Next, the printed material is inspected by comparing the correct image with the scan image (step S107). A CPU 421 determines whether the scan image is abnormal by comparing the correct image stored in the auxiliary storage device 442 with the scan image stored in the RAM 443. More specifically, the CPU 421 compares the correct image with the scan image by the unit of the page and determines whether the page of the printed material of the main printing, that is, the scan image is abnormal depending on the matching degree therebetween. Additionally, the page of the abnormal printed material can be discharged to a purge tray (not illustrated) so as to be distinguished from the page of the normal printed material.

The control unit 390 determines whether the printing of the specified number of copies ends (step S108) and continues the printing and scanning until the printing of the number of copies specified in the print job ends (step S108: NO). Then, when the printing of the specified number of copies ends (step S108: YES), the process ends.

In this way, in the process illustrated in FIG. 6, when the inspection setting is on, the image forming system 100 acquires the correct image so as to perform the main printing on the basis of the print job and acquires the scan image by scanning the printed material. Next, the image forming system 100 inspects the printed material by comparing the correct image with the scan image of the printed material. The steps from the main printing to the inspection of the printed material are repeated by the number of copies specified in the print job for each page of the print job.

<Correct Image Acquiring Process (Step S105)>

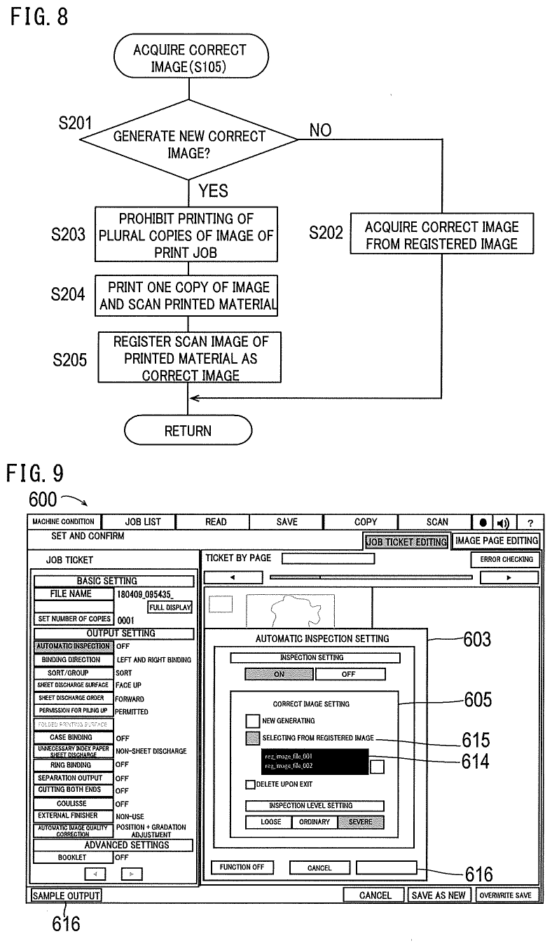

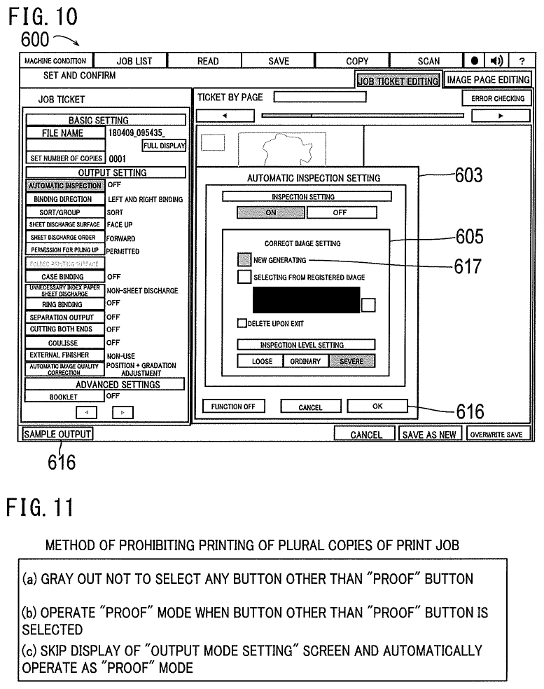

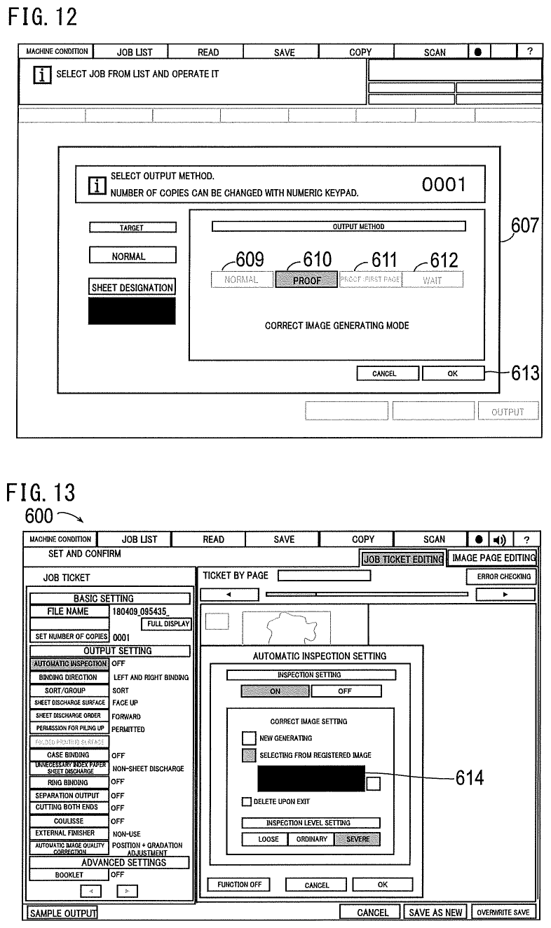

Next, a correct image acquiring process will be described in detail with reference to FIG. 8. FIG. 8 is a flowchart of a subroutine illustrating a process of acquiring a correct image. The process illustrated in FIG. 8 is realized by the cooperation of the control unit 390 and the control unit 440. Further, FIG. 9 is a schematic diagram illustrating the case of selecting the correct image from the registered image and FIG. 10 is a schematic diagram illustrating the case of newly generating the correct image. Further, FIG. 11 is a diagram illustrating a method of prohibiting the printing of a plurality of copies of the print job and FIG. 12 is a schematic diagram illustrating the case of graying out a selection button other than the “proof” button as one of methods of prohibiting the printing of the plurality of copies of the print job.

As illustrated in FIG. 8, it is first determined whether to newly generate the correct image (step S201). As illustrated in FIG. 9, the user can newly generate the correct image (a first acquiring method) or select the correct image from the registered image (a second acquiring method) on the “correct image setting” screen 605 of the “automatic inspection setting” screen 603. The “correct image setting” screen 605 functions as an acquiring method selection unit (method selector). Further, when the user selects the correct image from the registered image, an arbitrary registered image can be selected from a registered image list 614. When an “OK” button 616 is selected while “selection from registered image” 615 is selected on the “correct image setting” screen 605 (step S201: NO), the control unit 390 acquires the correct image from the registered image (step S202). The control unit 390 sets the registered image selected by the registered image list 615 as the correct image and ends the process (return).

Meanwhile, as illustrated in FIG. 10, when the “OK” button 616 is selected while “new generating” 617 is selected on the “correct image setting” screen 605 (step S201: YES), the printing of a plurality of copies of the image of the print job is prohibited (step S203).

As illustrated in FIG. 11, in the embodiment, the control unit 390 prohibits the printing of a plurality of copies of the image of the print job by performing any one of (a) to (c). When the instruction to start printing is received, the “output mode setting” screen 607 is launched as illustrated in FIG. 12.

(a) The control unit 390 controls the “output mode setting” screen 607 so that an output mode of printing only one copy of the image of the print job is selected by the user. More specifically, as illustrated in FIG. 12, the control unit 390 grays out a button other than the “proof” button 610 so that the button is not selected. Accordingly, the printing of a plurality of copies of the image of the print job by the image forming unit 330 is prohibited.

(b) Even when the user selects an output mode capable of printing a plurality of copies of the image of the print job through the “output mode setting” screen 607, the control unit 390 treats this selection as a selection of the output mode of printing only one copy of the image of the print job by the user. More specifically, the control unit 390 can select all of the “normal” button 609, the “proof” button 610, the “proof (first page)” button 611, and the “wait” button 612. However, the control unit 390 operates the image forming apparatus as the “proof” mode when a button other than the “proof” button 610 is selected. That is, the image forming apparatus is always operated as the “proof” mode even when any button is selected. Accordingly, the printing of a plurality of copies of the image of the print job by the image forming unit 330 is prohibited.

(c) The control unit 390 sets an output mode of printing only one copy of the image of the print job. More specifically, the control unit 390 automatically operates the image forming apparatus as the “proof” mode without displaying the “output mode setting” screen 607. That is, when the inspection setting is on after receiving the instruction to start printing, the display of the “output mode setting” screen 607 is skipped and the image forming apparatus is operated as the “proof” mode. Accordingly, the printing of a plurality of copies of the image of the print job by the image forming unit 330 is prohibited.

Further, the “output mode setting” screen 607 may be configured to function as a notification unit (a notifier) and notify the user of the printing of only one copy of the image of the print job. Accordingly, the user can easily recognize a state in which the image forming system 100 is operated as a mode of generating the correct image so that only one copy of the image is printed. FIG. 12 illustrates a case in which a massage that this mode is a “correct image generating mode” is displayed at a predetermined position within the area of the “output mode setting” screen 607.

Next, one copy of the image is printed and the printed material is scanned (step S204). As described above, since the printing of a plurality of copies of the image of the print job is prohibited when the “new generating” 617 of the “correct image setting” screen 605 is selected, only the printing in the “proof” mode is allowed and one copy of the image of the print job is printed. Additionally, in the “proof” mode, a proof printing print job that prints only one copy of the image on the basis of the print job stored in the auxiliary storage device 392 is generated and one copy of the image is printed on the basis of the print job.

Then, the printed material output by the image forming apparatus 300 is conveyed one by one to the first post-processing apparatus 400 and is scanned by the image reading unit 420. The scan image is stored in the RAM 443.

Next, the scan image of the printed material is registered as the correct image (step S205). The control unit 390 checks whether to register the scan image of the printed material as the correct image by the user after the printed material is discharged to the sheet discharge tray of the second post-processing apparatus 500. The control unit 390 registers the scan image as the correct image when the scan image of the printed material can be registered as the correct image and ends the process of acquiring the correct image (return).

In this way, according to the process illustrated in FIG. 8, a method or newly generating the correct image or a method of acquiring the correct image from the registered image is selected through the “correct image setting” screen 605 and the reference image is acquired in response to the selection result. When the correct image is newly generated, the control unit 390 prohibits the printing of a plurality of copies of the image of the print job by the image forming unit 330. Further, the correct image is generated by reading the image printed on the sheet by the image forming unit 330 using the image reading unit 420.

### Modified Example 1

FIG. 13 is a schematic diagram illustrating a modified example of correct image setting. In the modified example, it is assumed that the “inspection setting” is “ON”, the “correct image setting” is “selecting from registered images”, and no registered image is specified.

In this state, when the instruction to start printing is received, the “correct image setting” is selected from the “registered images”. However, since the registered images do not exist, the correct image cannot be selected from the registered images. Here, the control unit 390 performs control so that a correct image is newly generated in such a case.

Additionally, the “output mode setting” screen 607 may be configured to function as a notification unit so as to notify the user of the printing in an output mode (for example, a proof mode) of printing only one copy of the image of the print job.

### Modified Example 2

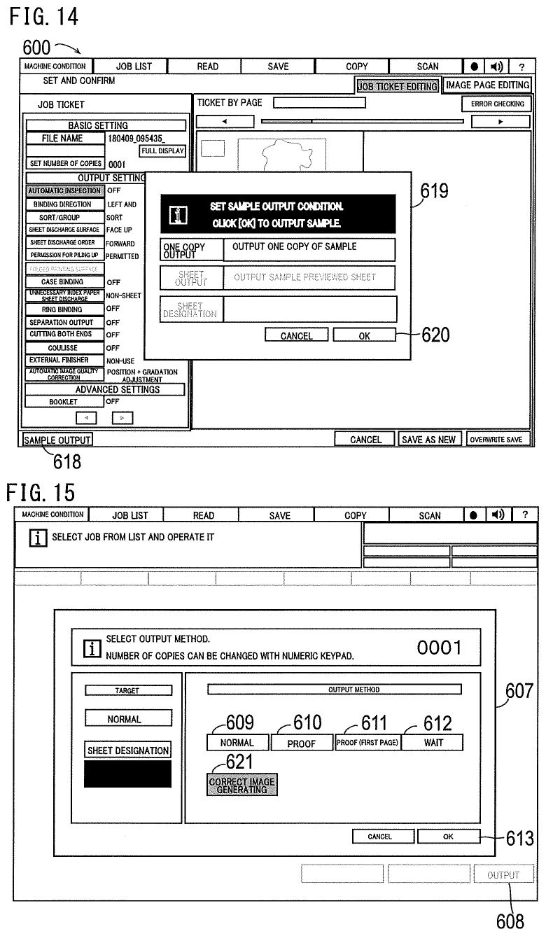

In the above-described example, the case of printing one copy of the image of the print job by the “proof” mode when newly generating the correct image has been described, but one copy of the image of the print job can be printed by a “sample output” mode. FIG. 14 is a schematic diagram illustrating the case of printing one copy of the image of the print job by the “sample output” mode.

In the modified example, it is assumed that the “inspection setting” is “ON” and the “correct image setting” is “new generating”. When the user selects a “sample output” button 618 of the “job ticket editing” screen 600, a “sample output setting” screen 619 is launched.

When the correct image is newly generated, only the condition of “outputting one copy” can be selected in the “sample output” mode. Thus, “sheet output” and “specify sheet” other than “one copy output” are grayed out and cannot be selected by the user. When the “OK” button 620 is selected, the sample output is started.

### Modified Example 3

In the above-described example, the case of newly generating the correct image from the “job ticket editing” screen 600 has been described, but the correct image can be newly generated from other than the “job ticket editing” screen 600.

FIG. 15 is a schematic diagram illustrating the case of newly generating the correct image from the “output mode setting” screen 607.

The “output mode setting” screen 607 functions as a mode selection unit and includes a “correct image generating” button 621 in addition to the “normal” button 609, the “proof” button 610, the “proof (first page)” button 611, and the “wait” button 612.

When the “correct image generating” button 621 and the “OK” button 613 are selected by the user, the new generating of the correct image is performed. When the correct image is newly generated from the “output mode setting” screen 607, the operation is simplified as compared with the case of newly generating the correct image from the “job ticket editing” screen 600 and hence the burden on the user can be reduced.

The image forming system 100 of the above-described embodiment has the following effect.

Since the printing of a plurality of copies of the image of the print job is prohibited, it is possible to prevent a setting error of the output mode by the user when newly generating the correct image. As a result, since the printing of a plurality of copies unintended by the user is avoided, the sheet is prevented from being used wastefully.

As described above, in the embodiment, the image forming system 100 and the control program have been described. However, it is needless to mention that the present invention can be appropriately added, modified, and omitted by the person skilled in the art within the scope of the technical spirit.

For example, a case in which the control unit 390 plays an important role in the processes of FIGS. 6 and 8 has been described, but the control unit 440 may be configured to play an important role.

Further, the control program of the image forming system 100 may be provided by a computer-readable recording medium such as a USB memory, a flexible disk, or a CD-ROM, or may be provided online via a network such as the internet. In this case, the program recorded on the computer-readable recording medium is usually transferred and stored in a memory, storage, or the like. Further, this control program may be provided as, for example, single application software or may be incorporated in the software of each device as one function of the image forming system 100.

Although embodiments of the present invention have been described and illustrated in detail, it is clearly understood that the same is by way of illustration and example only and not limitation, the scope of the present invention should be interpreted by terms of the appended claims.

1. An image forming system comprising:
an image former which forms an image on a sheet on the basis of a print job;
an image reader which reads an image on the sheet having the image formed thereon by the image former;
a reference image acquirer which acquires a reference image as a reference for determining whether or not the image of the print job formed on the sheet by the image former is normal; and
a controller which prohibits forming of a plurality of copies of the image of the print job by the image former when the reference image acquirer generates and acquires the reference image by reading the image formed on the sheet by the image former using the image reader.

2. The image forming system according to claim 1, further comprising:
an image inspector which determines whether or not the image of the print job formed on the sheet by the image former is normal on the basis of the reference image and the image read by the image reader.

3. The image forming system according to claim 1,
wherein the reference image acquirer generates and acquires the reference image or acquires the reference image from at least one registered image registered in advance.

4. The image forming system according to claim 3, further comprising:
a mode selector which allows a user to select one output mode from a plurality of output modes including an output mode capable of forming a plurality of copies of the image of the print job and an output mode of forming only one copy of the image,
wherein when the reference image acquirer generates and acquires the reference image, the controller prohibits forming of a plurality of copies of the image of the print job by the image former by controlling the mode selector so as to allow the user to select the output mode of forming only one copy of the image of the print job.

5. The image forming system according to claim 3, further comprising:
a mode selector which allows a user to select one output mode from a plurality of output modes including an output mode capable of forming a plurality of copies of the image of the print job and an output mode of forming only one copy of the image,
wherein when the reference image acquirer generates and acquires the reference image, the controller prohibits forming of a plurality of copies of the image of the print job by the image former by regarding that the user selects the output mode of forming only one copy of the image of the print job even when the user selects the output mode capable of forming a plurality of copies of the image of the print job through the mode selector.

6. The image forming system according to claim 3, comprising:
a plurality of output modes including an output mode capable of forming a plurality of copies of the image of the print job and an output mode of forming only one copy of the image, and
wherein when the reference image acquirer generates and acquires the reference image, the controller prohibits forming of a plurality of copies of the image of the print job by the image former by setting the output mode of forming only one copy of the image of the print job.

7. The image forming system according to claim 6, further comprising:
a notifier which notifies the user of forming of only one copy of the image of the print job when the reference image acquirer generates and acquires the reference image.

8. The image forming system according to claim 3, further comprising:
an acquiring method selector which allows a user to select one of a first acquiring method of generating and acquiring the reference image and a second acquiring method of acquiring the reference image from the at least one registered image,
wherein the reference image acquirer acquires the reference image in response to a selection result of the acquiring method selector.

9. The image forming system according to claim 8,
wherein the reference image acquirer acquires the reference image by changing an acquiring method to the first acquiring method when an instruction for starting of image forming on the basis of the print job is received while no registered image is specified even when the second acquiring method is selected through the acquiring method selector.

10. The image forming system according to claim 8, further comprising:
a notifier which notifies the user of forming of only one copy of the image of the print job when the reference image is acquired by the first acquiring method.

11. The image forming system according to claim 1, further comprising:
a mode selector which allows a user to select any output mode to form an image, from a plurality of output modes including an output mode capable of forming a plurality of copies of the image of the print job, an output mode of forming only one copy of the image, and an output mode of generating and acquiring the reference image by reading the image formed on the sheet by the image former using the image reader.

12. A non-transitory computer-readable storage medium storing a program causing a computer to perform:
(a) forming an image on a sheet on the basis of a print job;
(b) reading the image on the sheet having the image formed thereon by the step (a); and
(c) acquiring a scan image read by the step (b) as a reference image for determining whether or not the image formed by a main printing of the print job is normal,
wherein in the step (a), the forming of a plurality of copies of the image of the print job is prohibited.
